(19) United States
(12) Patent Application Publication
(10) Pub. No.: US 2024/0104360 A1
(43) Pub. Date: Mar. 28, 2024

(54) NEURAL NETWORK NEAR MEMORY PROCESSING

(71) Applicant: Alibaba Group Holding Limited, Georgetown, Grand Cayman (KY)

(72) Inventors: Tianchan GUAN, Shanghai (CN); Dimin NIU, Sunnyvale, CA (US); Hongzhong ZHENG, Los Gatos (CA); Shuangchen LI, Sunnyvale, CA (US)

(21) Appl. No.: 18/265,219

(22) PCT Filed: Dec. 2, 2020
(86) PCT No.: PCT/CN2020/133406

§ 371 Date: Jun. 2, 2023

(51) Int. Cl. G06N 3/063; G06N 3/04

(52) U.S. Cl. CPC G06N 3/063; G06N 3/04

(57) ABSTRACT

Near memory processing systems for graph neural network processing can include a central core coupled to one or more memory units. The memory units can include one or more controllers and a plurality of memory devices. The system can be configured for offloading aggregation, concentrate and the like operations from the central core to the controllers of the one or more memory units. The central core can sample the graph neural network and schedule memory accesses for execution by the one or more memory units. The central core can also schedule aggregation, combination or the like operations associated with one or more memory accesses for execution by the controller. The controller can access data in accordance with the data access requests from the central core. One or more computation units of the controller can also execute the aggregation, combination or the like operations associated with one or more memory access. The central core can then execute further aggregation, combination or the like operations or computations of end use applications on the data returned by the controller.

### BACKGROUND OF THE INVENTION

Graph neural networks (GNN) are utilized to model relationships in graph-based data such as, but not limited to, social networks, maps, transportation systems, and chemical compounds. Graph neural networks model the relationship between nodes representing entities and edges representing relationships to a produce a numeric representation of the graph. The numeric representation can be used for, but is not limited to, link prediction, node classification, community detection and ranking.

Referring to FIG. 1, an exemplary graph neural network is illustrated. The graph neural network can include a plurality of layers. The layers of a graph neural network can include a number of operations including aggregation, combination and the like function. The computations typically include a large amount of random memory accesses to large amounts of memory utilized to store the large datasets of the graph neural network that can be distributed across multiple machines.

Referring to FIG. 2, an exemplary system for processing a graph neural network, according to the conventional art, is shown. The system can include a central core 205 and one or more memory units 210. The central core 205 can include a compute engine 215 and a data engine 220. The compute engine 215 can be configured to compute aggregation, combination and the like operations along with computations of end use applications. The one or more memory units 210 can include a plurality of memory devices 225, 230 and a controller 235. The controller 235 can be configured to access (fetch and store) weight parameters, activations, attributes of nodes and edges of the graph and the like stored in the plurality of memory device 225, 230 in response to memory accesses generate by the data engine 220 for use by the compute engine 215. Referring now to FIG. 3, operations performed by the central core 205 and the one or more memory units 210, according to the conventional art, is illustrated. The central core can be configured to perform sampling in accordance with a graph neural network (GNN) model at 310. The one or more memory units 210 can be configured to access attributes of nodes and edges of a graph at 320. The central core 205 can then perform one or more aggregation functions, combination functions, and or end application computations using the accessed attributes at 330.

In the conventional system, the central core 205 can be subject to very high processing workload performing all the computations associated with graph neural network processing. In addition, the conventional system as subject to high bandwidth utilization associated with transferring attributes between the one or more memory units 210 and the central core 205 and back. In addition, the large datasets of the graph neural network can occupy a large amount of memory devices 225, 230. Accordingly, there is a continuing need for improved devices and method for performing computations associate with graph neural networks.

### SUMMARY OF THE INVENTION

The present technology may best be understood by referring to the following description and accompanying drawings that are used to illustrate embodiments of the present technology directed toward near memory processing for graph neural network and other neural network applications.

In one embodiment, a neural network processing system can include a central core coupled to one or more memory units. The memory units can include one or more memory device and one or more controllers. The controllers can be configured to compute aggregation, combination and other similar operations offloaded from the central core, on data stored in the one or more memory device.

In another embodiment, near memory processing method can include receiving, by a controller, a first memory access including aggregation, combination and or similar operations. The controller can access attributes based on the first memory access. The controller can compute the aggregation, combination and or other similar operations on the attributes base on the first memory access to generate result data. The controller can output the result data based on the first memory accesses. The result data output by the controller can be a partial result that a central core can utilize for completing aggregation, combination and or similar operations. In response to a second memory access that does not include an aggregation, combination and or similar operation, the controller can access attributes based on the second memory access. The controller can then output the attributes based on the second memory request.

In another embodiment, a controller can include a plurality of computation units and control logic. The control logic can be configured to receive a memory access including an aggregation and or combination operation, and access and compute the attributes based on the operation included in the memory access. The control logic of the controller can configure one or more of the plurality of computation units of the controller to compute the aggregation or combination operation on the attributes, based on the operation of the memory access, to generate result data. The control logic of the controller can then output the result data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 illustrates an exemplary graph neural network.

FIG. 2 shows an exemplary system for processing a graph neural network, according to the conventional art.

FIG. 3 illustrates operations performed by the central core and the one or more memory units, according to the conventional art.

FIG. 4 shows a system for processing a graph neural network, in accordance with aspects of the present technology.

FIG. 5 shows an exemplary system for processing a graph neural network, in accordance with aspects of the present technology.

FIG. 6 shows operations performed by the central core and the one or more memory units, according to aspects of the present technology.

FIG. 7 shows a method of near memory computation, in accordance with aspects of the present technology.

FIG. 8 shows a method of storing data, in accordance with aspects of the present technology.

FIG. 9 shows a method of fetching data and optionally performing near memory computations, in accordance with aspects of the present technology.

FIG. 10 illustrates exemplary operation of a system for processing a graph neural network, in accordance with aspects of the present technology.

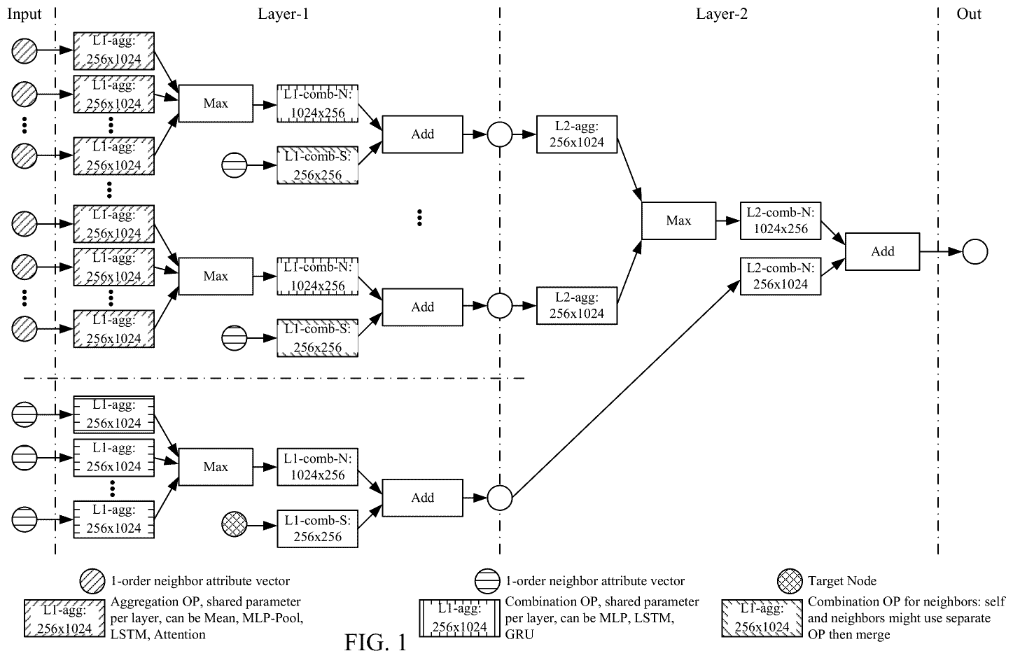

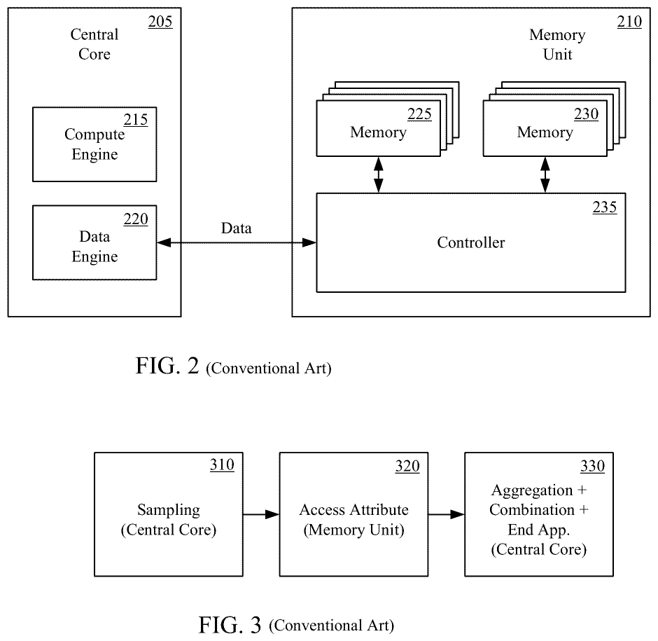

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and or the like, refer to the actions and processes of an electronic device such as an electronic computing device that manipulates and transforms data. The data is represented as physical (e.g., electronic) quantities within the electronic device's logic circuits, registers, memories and or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

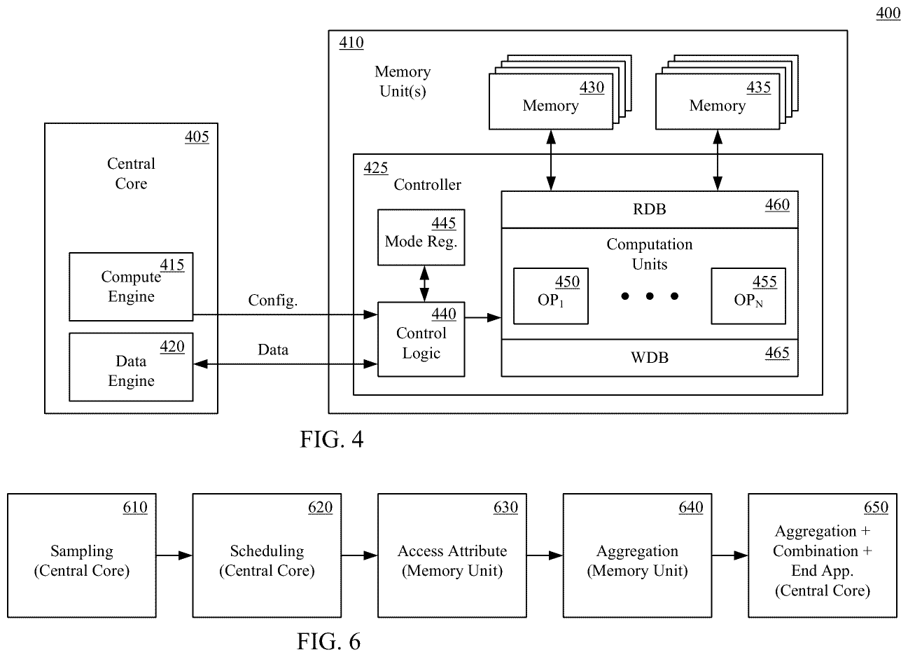

Referring to FIG. 4, a system configured for near memory computation, in accordance with aspects of the present technology, is shown. The system 400 can include a central core 405 and one or more memory units 410. The central core 405 can include a compute engine 415 and a data engine 420. The one or more memory units 410 can include a controller 425 and a plurality of memory devices 430, 435. The plurality of memory devices 430, 435 and one or more controllers 425 are tightly coupled together in the memory unit to provide for near-memory computing. In one implementation, the plurality of memory devices 430, 435 can include a plurality of non-volatile memory device organized in a plurality of memory channels. For example, the memory device 430, 435 can be a plurality of dynamic random-access memory (DRAM) chips organized in two or more memory access channels. The controller 425 can include control logic 440, a mode register 445, a plurality of computation units 450-455, a read data buffer (RDB) 460 and a write data buffer (WDB) 465.

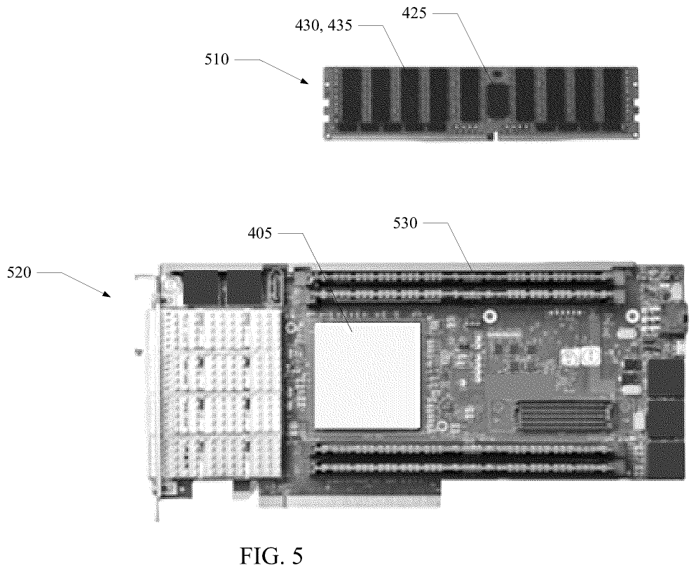

Referring now to FIG. 5, the controller 425 can be implemented as application specific integrated circuit (ASIC), field programmable gate array (FPGA) or similar chip. In one implementation, the memory devices 430, 435 can be dynamic random-access memory (DRAM) chips, flash memory chips, phase change memory (PCM) chips or the like. The one or more memory units 410 can include a plurality of memory device 430, 435 chips and one or more controller 425 chips arranged on a memory card printed circuit board assembly (PCBA). The plurality of memory devices 430, 435 chips and one or more controllers 425 chips are tightly coupled together in the memory unit to provide for near-memory computing. In one implementation, the one or more memory units 410 can be memory cards 510, such as but not limited to, dual in-line memory module (DIMM) cards, small-outline DIMM, or micro-DIMM. In one implementation, the system for near memory computation 400 can be implemented as a card 520, such as but not limited to, a peripheral component interface express (PCIe) card. The system card 520 can be a printed circuit board assembly (PCBA) including, but not limited to, a plurality of dual in-line memory module (DIMM) sockets 530 and one or more central cores 405.

Referring again to FIG. 4, the central core 405 and one or more memory units 410 can be configured for offloading computations from the central core 405 to the one or more memory unit 410. In one implementation, aggregation, combination and other computations can be offloaded from the central core 405 to the one or more memory units 410. For example, aggregation and or combination functions of graph neural networks can be offloaded for near memory processing by the one or more memory units 410. In one implementation, computations can be offloaded from the central core 405 to the one or more memory unit 410 utilizing extensions to read and write memory commands. The read memory access can be extended to a read with compute (read_w_comp) access, and the write memory access can be extended to write with compute (write_w_comp) access. The extensions can include data address, data count, and data stride extension. The extensions can be embedded into a coherent interconnect (GenZ/CXL) data package, extended double data rate (DDR) command or the like. Referring to Table 1, an exemplary set of DDR commands that can be used to embed the extensions above are shown.

Operation of the central core 405 and the one or more memory units 410 will be further explained with reference to FIG. 6. The central core 405 can be configured to perform sampling operations 610 of a graph neural network model. The central core 405 can also be configured to schedule execution of one or more aggregation, combination and or the like functions 620 by one or more memory unit 410. The one or more memory units 410 can access attributes 630. The one or more memory unit 410 can also perform the one or more scheduled aggregation, combination and or the like functions 640 on the accessed attributes. The central core 405 can further perform aggregation, combination and or the like functions, along with computations of end use applications 650.

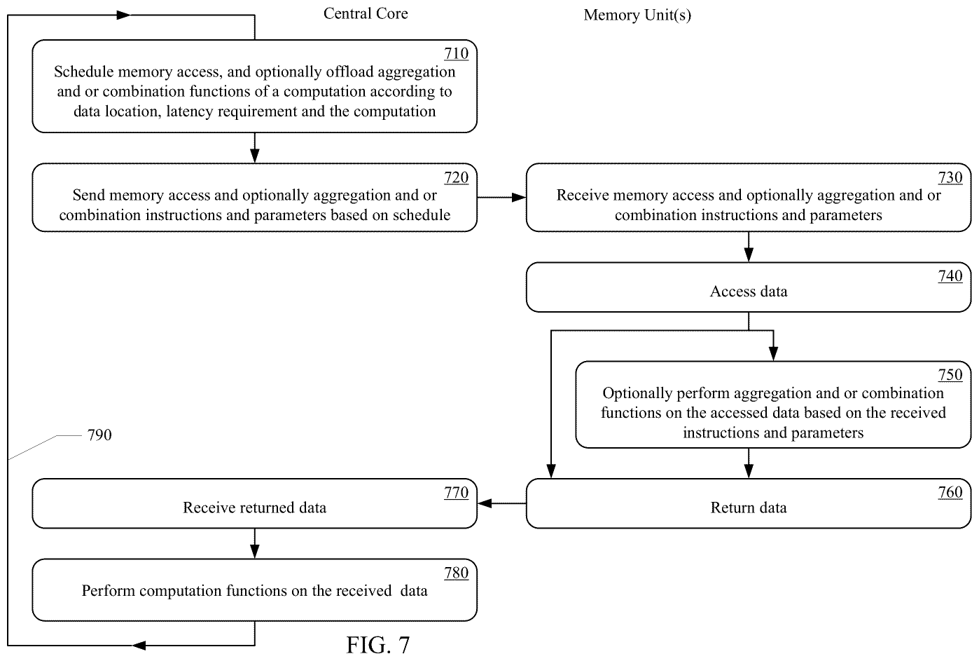

Referring now to FIG. 7, a method of near memory computation, in accordance with aspects of the present technology, is shown. The near memory computation method will be explained with reference to FIG. 4. The method of near memory computation can include scheduling a memory access and optionally scheduling one or more aggregation, combination and or the functions to be performed by one or more memory units 410, at 710. The central core 405 can schedule the aggregation, combination and or the like functions by offloading to the one or more memory unit 410 based on location of data associated with the memory access, the aggregation, combination and or like functions, latency associated with the memory access, computation of the aggregation, combination or the like functions, the computation workload of the aggregation, combination and or like functions, and or the like. At 720, a memory access and optionally aggregation, combination or the like instructions and parameters can be sent by the central core based on the scheduled memory access and optional offloaded aggregation, combination and or the like functions. In one implementation, the central core can pass read with compute (read_w_comp) access, and write with compute (write_w_comp) access extensions to offload corresponding aggregation, combination and or the like functions. The extensions can include data address, data count, and data stride extensions. The extensions can be embedded into a coherent interconnect (GenZ/CXL) data package, extended double data rate (DDR) command, or the like. Table 2 shows exemplary read and write extensions.

TABLE 2
Read data from Addr to RDB 455

| | | |
|---|---|---|
| R_B | off | Addr |

Write data to WDB 460

| | | |
|---|---|---|
| W_B | off | RFU |

Read results from Results_Buffer

| | | |
|---|---|---|
| RES | RW | RFU |

Write data to WDB 460

| | | |
|---|---|---|
| RES | RW | Addr |

Compute Operation (OP) from buffer
(RW) w/SIMD width (SIMD). Results
saved to Result_Buffer

| | | | | |
|---|---|---|---|---|
| CMP | RW | OP | SIMD | RFU |

Tables 3 and 4 show exemplary commands and parameters for the read and write extensions.

TABLE 3
Command

| | |
|---|---|
| R_B | Read to buffer |
| W_B | Write to buffer |
| RES | R/W result |
| CMP | Compute |

TABLE 4
Parameter

| | |
|---|---|
| Off | Buffer offset |
| RW | Read/Write |
| OP | Operation Type |
| SIMD | SIMD Width |

The controller 425 can support several computation modes. In one implementation, the modes can include no computation, complete computation and partial computation. The configuration parameters passed in the memory access from the compute engine 415 of the central core 405 to the controller 425 of a given memory unit 410 can set a given mode in the mode register 440 of the controller 425.

At 730, the memory access can be received by a given one of the one or more memory units 410. Optionally one or more aggregation, combination and or the like instructions can also be received with the memory access. In one implementation, the aggregation, combination and or the like instructions can be received as read with compute (read_w_comp) access, or write with compute (write_w_comp) memory access extensions. At 740, data can be accessed in accordance with the received memory access. At 750, optional aggregation, combination and or the like functions can be performed on the accessed data based on the received instructions and parameters. In one implementation, the mode register 440 can control the computations performed by the plurality of computation units 440-445. The read data buffer (RDB) 445 and write data buffer (WDB) 460 can be multi-entry buffers used to buffer data for the computation units 440-445. The modes can include no computation, complete computation and partial computation modes. In the no computation mode, the read data buffer (RDB) 445 and write data buffer (WDB) 460 can be bypassed. In the complete computation mode, the computation units 440-445 can perform all the computations on the accessed data. In the partial computation mode, the computation units 440-445 can perform a portion of the computations on the accessed data and a partial result can be passed as the data for further computations by the compute engine 415 of the central core 405. The result data of the optional aggregation, combination or the like function can be sent by the one or more memory units 410 as return data, at 760. In addition, when the memory access does not also include optional aggregation, combination or the like instructions and parameters, the accessed data can be returned by the one or more memory units as return data, at 760.

At 770, the returned data can be received by the central core 405. At 780, the central core 405 can perform computation functions on the returned data. In a no computation mode, the central core 405 can for example perform computations on attributes of the memory access returned by the memory unit. In a complete computation mode, the central core 405 can perform, in another example, other computations on the aggregation, combination or the like data returned for the memory access by the memory unit 410. In a partial computation mode, the central core 405 can perform, in yet another example, further aggregation, combination or the like functions on the partial result data returned for the memory access by the memory unit 410. At 790, the processes at 710-780 can be iteratively performed for a plurality of memory accesses.

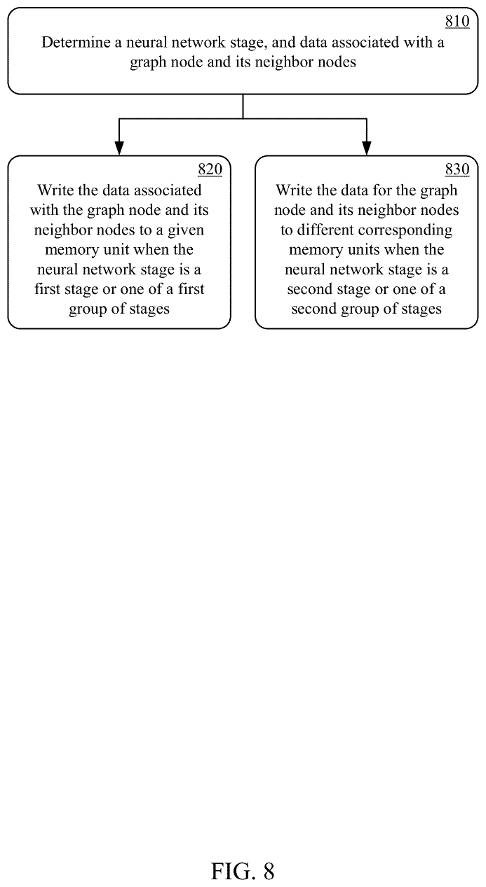

Referring not to FIG. 8, a method of storing data, in accordance with aspects of the present technology, is shown. The method can include determining a neural network mode, and data associated with a graph node and its neighbor nodes, at 810. At 820, the data associated with the graph node and its neighbor node can be written to a given memory unit when the neural network mode is a first mode or one of a first group of modes. For example, in a low-throughput inference mode, the data for a graph node and its neighbor nodes can be placed in the memory of one memory unit. At 830, the data for different nodes can be written to different corresponding memory units when the neural network mode is a second mode or one of a second group of modes. For example, in a training or a high-throughput inference mode, the data of neighbor nodes can be placed in separate memory units for increased computational parallelism and reduced data transfer between the memory units and central core.

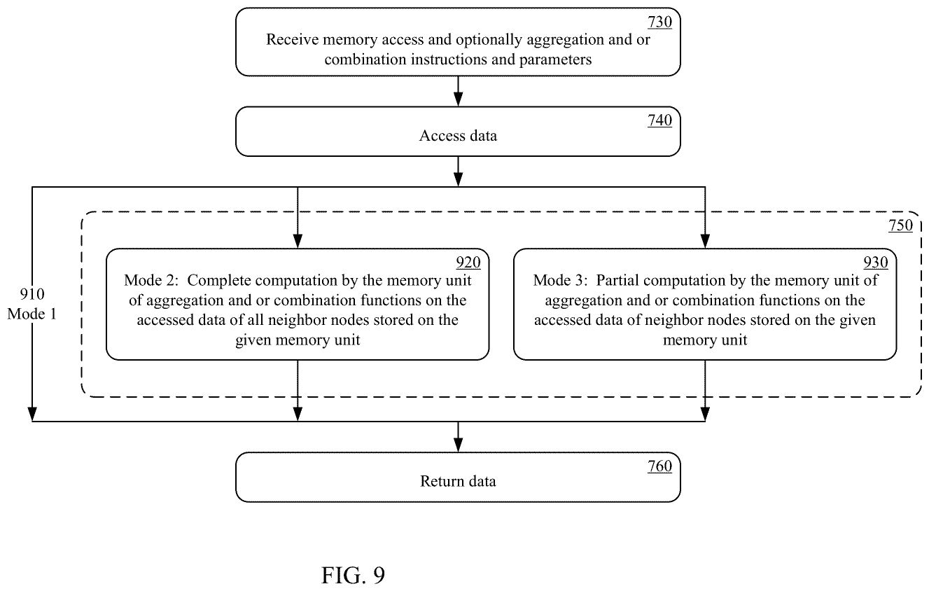

Referring now to FIG. 9, a method of fetching data and optionally performing near memory computations, in accordance with aspects of the present technology, is shown. The method can include receiving a memory access and optionally receiving aggregation, combination and or the like instructions and parameters, at 730. In one implementation, a parameter can indicate one of a plurality of modes. For example, the parameter can indicate one of a no computation mode, a complete computation mode, and a partial computation mode. At 740, data in one or more memory devices of a memory unit can be accessed by a controller of the memory unit. In one implementation, the data can be accessed based on a received memory access and optionally one or more aggregation, combination and or the like instructions and parameters.

In a first mode, the accessed data can be returned by the one or more memory units to a host, when the memory access does not include aggregation, combination and or the like instructions, at 910. For example, in the no computation mode, the controller 425 does not perform any computation, and instead transfers attribute data to the central core. The central core 405 may then perform aggregation, combination and or the like computations, or any end use application function on the returned data.

In a second mode, the memory unit can complete one or more aggregation, combination and or the like functions on the accessed data, at 920. For example, in a complete computation mode, the controller 425 can compute aggregation, combination and or the like functions on the accessed data before passing the results to the central core 405. The central core 405 can then use the result for one or more further computations.

In a third mode, the memory unit can perform partial computations including one or more aggregation, combination and or the like functions on the accessed data, at 930. For example, in a partial computation mode, the controller 425 can compute partial results for aggregation, combination and or the like functions before passing the partial results to the central core 405. The central core 405 can then use the partial results for one or more further computations. In one implementation of a partial compute mode, a computation can be the mean aggregation function:

aggr=Σᵢ₌₁ⁿfᵢ/n (1)

where f is the attributes of the nodes, n the number of the nodes, and aggr the result of aggregation function respectively.

A plurality of controllers, in the partial compute mode, can compute the aggregation partial results:

aggrₚ=Σᵢ₌₁^{k}fᵢ/n (k<n) (2)

Where k is the number of nodes that are stored in the memory unit, n the total number of nodes, and aggrₚ the partial result of aggregation function.

The central core, in partial compute mode, can complete the aggregation on the partial results received from the controllers:

aggr=Σⱼ₌₁^{m}aggrₚ^{m}/n (3)

where m is the number of memory units that participate computation of aggregation function.

In another implementation, a computation can be the mean/max pooling aggregator:

aggr=Σᵢ₌₁ⁿMLP(fᵢ)/n or max(MLP(fᵢ)): i=1,2,3 . . . n (4)

A plurality of controllers can compute the aggregation partial results:

aggrₚ=Σᵢ₌₁^{k}MLP(fᵢ)/n or max(MLP(fᵢ)): i=1,2,3 . . . k (5)

The central core can complete the aggregation on the partial results received from the controllers:

aggr=Σⱼ₌₁^{m}aggrₚ^{m}/n or max(aggrₚ^{m}): i=1,2,3 . . . m (6)

At 760, the attribute data for the first mode, or the results or partial results data from the second or third mode respectively can be sent by the memory unit as return data to the central core. Accordingly, the memory unit can provide for returning attribute data to the central core 405, or provide for offloading of complete or partial near memory computation of aggregation, combination and or the like functions by the controller 245.

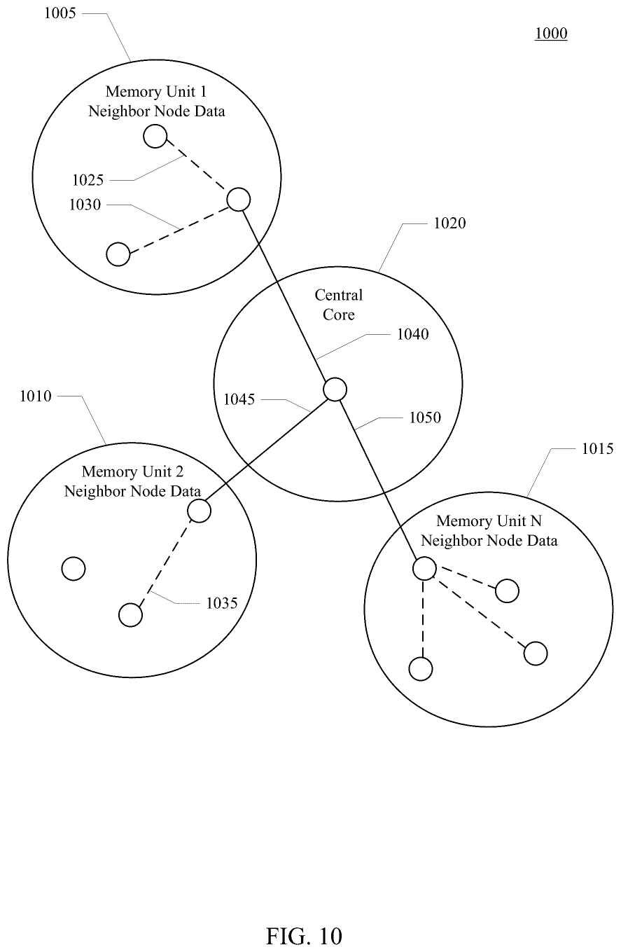

Referring now to FIG. 10, execution of aggregation, combination and or the like functions by a near memory compute system, in accordance with aspects of present technology, is illustrated. The near memory compute system 1000 can include a plurality of memory units 1005-1015 and a central core 1020. Data for a plurality of neighbor nodes can be stored on respective ones of the plurality of memory units 1005-1015. Partial computations can be offloaded from the central core 1020 to the plurality of memory units 1005-1015. For example, the first memory unit 1005 can perform aggregation and or combination functions to compute a first partial result for data of neighbor nodes 1025, 1030 of a graph neural network model stored on the first memory unit 1005. The second memory unit 1010 can perform aggregation and or combination functions to compute a second partial result for data of neighbor nodes 1035 stored on the second memory unit 1010. The central core 1020 can receive partial results 1040-1050 returned by the plurality of memory units 1005-1015 and perform further aggregation and or combination functions on the partial results 1040-1050.

Aspects of the present technology advantageously provide memory units operable for near memory processing. The near memory processing can advantageously reduce the overhead and latency of data transactions between the memory devices and central cores. The memory units can advantageously support computation of neighbor node data and the like in parallel.

The following examples pertain to specific technology embodiments and point out specific features, elements, or steps that may be used or otherwise combined in achieving such embodiments.

Example 1 includes a neural network processing system comprising: a central core; and one or more memory units coupled to the central core. The respective memory units include: one or more memory devices; and a controller coupled to the one or more memory devices and configured to perform aggregation operations on data stored in the one or more memory device of the respective memory unit offloaded from the central core.

Example 2 includes the system of Example 1, wherein the controller comprises: a mode register configured with a given one of a plurality of compute modes; and a plurality of computation units configured to perform the aggregation operations on data based on the given compute mode in the mode register.

Example 3 includes the system of Example 2, wherein the plurality of compute modes include a no compute mode, a complete compute mode and a partial compute mode.

Example 4 includes the system of Example 1, wherein the controller is further configured to: receive a first memory access including an aggregation operation; access attributes in the respective one or more memory devices based on the first memory access; compute the aggregation operation on the attributes base on the first memory access to generate result data; and output the result data based on the first memory accesses to the central core.

Example 5 includes the system of Example 4, wherein the central core is configured to: schedule the first memory access including the aggregation operation; send the first memory access including the aggregation operation to the controller; and receive the result data based on the first memory accesses from the controller.

Example 6 includes the system of Example 5, wherein the central core is further configured to: compute a further aggregation operation on the result data received from the controller.

Example 7 includes the system of Example 4, wherein the controller is further configured to: receive a second memory access request; access attributes in the respective one or more memory devices based on the second memory access; and output the attributes based on the second memory request to the central core.

Example 8 includes a near memory processing method comprising: receiving, by a controller, a first memory access including an aggregation operation; accessing, by the controller, attributes based on the first memory access; computing, by the controller, the aggregation operation on the attributes based on the first memory access to generate result data; and outputting, from the controller, the result data based on the first memory accesses.

Example 9 includes the near memory processing method according to Example 8, wherein the aggregation operation comprises a graph neural network aggregation operation.

Example 10 includes the near memory processing method according to Example 8, wherein the memory access including the aggregation operation comprises a read with compute extension or a write with compute extension.

Example 11 includes the near memory processing method according to Example 10, wherein the compute extension can include a data address, data count and data stride.

Example 12 includes the near memory processing method according to Example 10, wherein the compute extension is embedded in a GenZ/CXL data package, or extended DDR command.

Example 13 includes the near memory processing method according to Example 8, wherein a mode of the first memory access including the aggregation operation includes a complete compute mode or a partial compute mode.

Example 14 includes the near memory processing method according to Example 8, further comprising: receiving, by the controller, a second memory access request; accessing, by the controller, attributes based on the second memory access; and outputting, from the controller, the attributes based on the second memory request.

Example 15 includes the near memory processing method according to Example 14, wherein the second memory access includes a read or write.

Example 16 includes the near memory processing method according to Example 14, wherein a mode of the second memory access includes a no compute mode.

Example 17 includes the near memory processing method according to Example 8, further comprising: scheduling, by a central core, the first memory access including the aggregation operation; sending, by the central core, the first memory access including the aggregation operation to the controller; and receiving, by the central core, the result data based on the first memory accesses from the controller.

Example 18 includes the near memory processing method according to Example 17, further comprising: computing, by the central core, a further aggregation operation on the result data received from the controller.

Example 19 includes the near memory processing method according to Example 8, further comprising: determining, by a central core, a neural network stage and data associated with a graph node its neighbor nodes; writing, by the central core, the data associated with the graph node its neighbor nodes to a given memory unit when the neural network stage is a first stage or one of a first group of stages; and writing, by the central core, the data for different nodes or different groups of nodes of the graph node and its neighbor nodes to different corresponding memory units when the neural network stage is a second stage or one of a second group of stages.

Example 20 includes the near memory processing method according to Example 19, wherein: the first stage or first group of stages includes one or more of a graph neural network training stage and high-throughput graph neural network inference stage; and the second stage or second group of stages includes a low-throughput graph neural network inference stage.

Example 21 includes a controller comprising: a plurality of computation units; and control logic configured to: receive a first memory access including an aggregation operation; access attributes based on the first memory access; configure one or more of the plurality of computation units to compute the aggregation operation on the attributes based on the first memory access to generate result data; and output the result data based on the first memory accesses.

Example 22 includes the controller of Example 21, wherein the control logic is further configured to: receive a second memory access request; access attributes based on the second memory access; and output the attributes based on the second memory request.

Example 23 includes the controller of Example 21, wherein the memory access including the aggregation operation comprises a read with compute extension or a write with compute extension.

Example 24 includes the controller of Example 21, wherein the compute extension can include a data address, data count and data stride.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A neural network processing system comprising:
a central core; and
one or more memory units coupled to the central core, wherein respective memory units include:
one or more memory devices; and
a controller coupled to the one or more memory devices and configured to perform aggregation operations on data stored in the one or more memory device of the respective memory unit offloaded from the central core.

2. The system of claim 1, wherein the controller comprises:
a mode register configured with a given one of a plurality of compute modes; and
a plurality of computation units configured to perform the aggregation operations on data based on the given compute mode in the mode register.

3. The system of claim 2, wherein the plurality of compute modes include a no compute mode, a complete compute mode and a partial compute mode.

4. The system of claim 1, wherein the controller is further configured to:
receive a first memory access including an aggregation operation;
access attributes in the respective one or more memory devices based on the first memory access;
compute the aggregation operation on the attributes base on the first memory access to generate result data; and
output the result data based on the first memory accesses to the central core.

5. The system of claim 4, wherein the central core is configured to:
schedule the first memory access including the aggregation operation;
send the first memory access including the aggregation operation to the controller; and
receive the result data based on the first memory accesses from the controller.

6. The system of claim 5, wherein the central core is further configured to:
compute a further aggregation operation on the result data received from the controller.

7. The system of claim 4, wherein the controller is further configured to:
receive a second memory access request;
access attributes in the respective one or more memory devices based on the second memory access; and
output the attributes based on the second memory request to the central core.

8. A near memory processing method comprising:
receiving, by a controller, a first memory access including an aggregation operation;
accessing, by the controller, attributes based on the first memory access;
computing, by the controller, the aggregation operation on the attributes based on the first memory access to generate result data; and
outputting, from the controller, the result data based on the first memory accesses.

9. The near memory processing method according to claim 8, wherein the aggregation operation comprises a graph neural network aggregation operation.

10. The near memory processing method according to claim 8, wherein the memory access including the aggregation operation comprises a read with compute extension or a write with compute extension.

11. The near memory processing method according to claim 10, wherein the compute extension can include a data address, data count and data stride.

12. The near memory processing method according to claim 10, wherein the compute extension is embedded in a GenZ/CXL data package, or extended DDR command

13. The near memory processing method according to claim 8, wherein a mode of the first memory access including the aggregation operation includes a complete compute mode or a partial compute mode.

14. The near memory processing method according to claim 8, further comprising:
receiving, by the controller, a second memory access request;
accessing, by the controller, attributes based on the second memory access; and
outputting, from the controller, the attributes based on the second memory request.

15. The near memory processing method according to claim 14, wherein the second memory access includes a read or write.

16. The near memory processing method according to claim 14, wherein a mode of the second memory access includes a no compute mode.

17. The near memory processing method according to claim 8, further comprising:
scheduling, by a central core, the first memory access including the aggregation operation;
sending, by the central core, the first memory access including the aggregation operation to the controller; and
receiving, by the central core, the result data based on the first memory accesses from the controller.

18. The near memory processing method according to claim 17, further comprising:
computing, by the central core, a further aggregation operation on the result data received from the controller.

19. The near memory processing method according to claim 8, further comprising:
determining, by a central core, a neural network stage and data associated with a graph node its neighbor nodes;
writing, by the central core, the data associated with the graph node its neighbor nodes to a given memory unit when the neural network stage is a first stage or one of a first group of stages; and
writing, by the central core, the data for different nodes or different groups of nodes of the graph node and its neighbor nodes to different corresponding memory units when the neural network stage is a second stage or one of a second group of stages.

20. The near memory processing method according to claim 19, wherein:
the first stage or first group of stages includes one or more of a graph neural network training stage and high-throughput graph neural network inference stage; and
the second stage or second group of stages includes a low-throughput graph neural network inference stage.

21. A controller comprising:
a plurality of computation units; and
control logic configured to:
receive a first memory access including an aggregation operation;
access attributes based on the first memory access;
configure one or more of the plurality of computation units to compute the aggregation operation on the attributes based on the first memory access to generate result data; and
output the result data based on the first memory accesses.

22. The controller of claim 21, wherein the control logic is further configured to:
receive a second memory access request;
access attributes based on the second memory access; and
output the attributes based on the second memory request.

23. The controller of claim 21, wherein the memory access including the aggregation operation comprises a read with compute extension or a write with compute extension.

24. The controller of claim 21, wherein the compute extension can include a data address, data count and data stride.
